(19) United States
(12) Patent Application Publication
(10) Pub. No.: US 2005/0135867 A1
(43) Pub. Date: Jun. 23, 2005

(54) Substance packaging and applicator device

(76) Inventor: Jean-Louis H. Gueret, Paris (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/962,674

(22) Filed: Oct. 13, 2004

Related U.S. Application Data
(60) Provisional application No. 60/514,612, filed on Oct. 28, 2003.

(30) Foreign Application Priority Data
Oct. 13, 2003 (FR) 03 11961

(51) Int. Cl. B43K 5/14; B43K 8/22

(52) U.S. Cl. 401/205; 401/196

(57) ABSTRACT

A device for packaging and applying a substance may include a first space inside a receptacle for containing a supply of substance, an applicator member suitable for applying the substance, and a wall extending between the first space and the applicator member. The device may also include a chimney that may extend from the wall and define a second space therein. The device may also include at least one orifice providing flow communication between the first and second spaces, and a third space capable of being supplied with the substance and separated at least partially from the second space by at least the chimney.

This application claims the benefit under 35 U.S.C. § 119(e) of U.S. provisional application No. 60/514,612, filed Oct. 28, 2003.

The present invention relates to a device for packaging and applying a substance. For example, the invention may relate to a device comprising a receptacle for containing a supply of substance and an applicator member being suitable for applying the substance and being fastened to the receptacle.

Such a device is described in, for example, EP 0 872 193 A1, FR 2 800 041, and EP 1 312 280 A1.

However, there still exists a need for a device that may be adapted to dispense a substance over a relatively large area, such as, for example, the chest or the legs.

Although the present invention may obviate the above-mentioned need, it should be understood that some aspects of the invention may not necessarily obviate that need.

In the following description, certain aspects and embodiments will become evident. It should be understood that the invention, in its broadest sense, could be practiced without having one or more features of these aspects and embodiments. It should be understood that these aspects and embodiments are merely exemplary.

In one aspect of the invention, as embodied and broadly described herein, the invention may provide a device for packaging and applying a substance, comprising a first space inside a receptacle for containing a supply of substance, an applicator member suitable for applying the substance, a wall extending between the first space and the applicator member, at least one chimney extending from the wall and defining a second space therein, at least one orifice providing flow communication between the first and second spaces, and a third space capable of being supplied with the substance and separated at least partially from the second space by at least the chimney, wherein the chimney may comprise at least one opening for permitting flow of the substance between the second space and the third space.

In another aspect of the invention, a device for packaging and applying a substance may comprise a first space inside a receptacle for containing a supply of substance, an applicator member suitable for applying the substance, a wall extending between the first space and the applicator member, at least one chimney extending from the wall and defining a second space therein, and a plurality of orifices providing flow communication between the first and second spaces, wherein the chimney may extend at least partially inside the applicator member.

In still another aspect of the invention, a device for packaging and applying a substance may comprise a first space inside a receptacle for containing a supply of substance, an applicator member suitable for applying the substance, a wall extending between the first space and the applicator member, at least one chimney extending from the wall and defining a second space therein (i.e., in the chimney), at least one orifice providing flow communication between the first and second spaces, and a third space capable of being supplied with the substance and separated at least partially from the second space by at least the chimney, wherein the chimney may be configured to enable a communication of the substance between the second space and the third space.

Various aspects of the invention may provide a device for packaging and applying a substance, comprising a first space inside a receptacle for containing a supply of substance, an applicator member suitable for applying the substance, a wall extending between the first space and the applicator member, at least one chimney extending from the wall and defining a second space therein, at least one orifice providing flow communication between the first and second spaces, and a third space capable of being supplied with the substance and separated at least partially from the second space by at least the chimney, wherein the wall and the chimney may be configured to permit the substance contained in the second and third spaces to return to the first space when the device is in a head-up position.

In another aspect of the invention, a device for packaging and applying a substance may comprise a first space inside a receptacle for containing a supply of substance, an applicator member suitable for applying the substance, a wall extending between the first space and the applicator member, at least one chimney extending from the first wall and defining a second space therein, at least one orifice providing flow communication between the first and second spaces, a third space capable of being supplied with the substance and separated at least partially from the second space by at least the chimney, and a flow controller for controlling flow of the substance. The flow controller, such as, for example, a valve or a pump, may serve as means for distributing the substance to the applicator member.

In one aspect, the at least one orifice may comprise a plurality of orifices opening out into the first and second spaces.

In another aspect, the chimney may contact a base portion of the applicator member.

According to still another aspect, the third space may be in fluid communication with the first space via at least one orifice formed through the wall and opening out into the first and third spaces. The third space may be in fluid communication with the first space via the second space. Alternatively or additionally, the third space may communicate with the second space via at least one slot formed in the chimney.

In various aspects, the chimney may comprise a free end opposite from the wall, and the free end may be substantially in contact with the applicator member. The chimney may thus support the applicator member while it is being pressed against the surface being treated so as to improve comfort during application.

Alternatively, the chimney may comprises a free end opposite from the wall, and the free end may be spaced apart from the applicator member by, for example, a gap that may be selected to be of greater or lesser extent depending on many factors, such as, for example, whether it is desirable to have the chimney to contribute to holding of the applicator member and whether it is desirable to form a chamber that is capable of containing the substance above the chimney. The presence of the gap may impart more or less flexibility to the applicator member while it is being applied to the surface being treated.

In another aspect, the applicator member may extend at least partially around and above the second and third spaces when, for example, the receptacle is in a head-up position (i.e. when the applicator member is situated above the supply of substance).

In still another aspect, the wall and the chimney may be configured such that, when the device is held in a head-up position, substance contained in the second and third spaces may return to the first space.

According to some aspects, the chimney may be substantially cylindrical. An outer diameter of the chimney may range from about 5 mm to about 10 mm.

In various aspects, the chimney may comprise a plurality of chimneys. For example, the chimney may comprise a first chimney and at least one second chimney surrounding the first chimney. The third space may be defined at least partially between the first and second chimneys. In an aspect, the first and second chimneys may be coaxial, thereby enabling the applicator member to be fed in a uniform manner. By arranging the chimneys (e.g., selecting the dimension, number, shape, position, and/or flow area or passage of the chimneys), it may be possible to control the flow rate of the substance during utilization.

In another aspect, the second chimney may also be substantially cylindrical. An outer diameter of the second chimney may range from about 12 mm to about 90 mm.

In one aspect, the height of at least one of the chimneys may be greater than or equal to about 5 mm and, in particular, greater than or equal to about 10 mm. The height may range from about 15 mm to about 40 mm.

In still another aspect, the chimney may be a first chimney, and the device may further comprise a second chimney. The third space may be defined inside the second chimney.

In yet still another aspect, the second chimney may not surround the first chimney.

In some aspects, an outer diameter of the second chimney may be greater than or equal to twice an outer diameter of the first chimney. Alternatively, an outer diameter of the second chimney may be substantially equal to three times an outer diameter of the first chimney.

One aspect of the invention may further comprise an outer skirt extending from the wall and cooperating with the second chimney to define a groove configured to receive a base portion of the applicator member. The groove may be an annular groove. The outer skirt may include a suitable mechanism (e.g., screw-fastening or snap-fastening) on its outside for fastening a cap for closing the receptacle.

In various aspects, the first and second chimneys may be made integrally by, for example, molding a plastic material.

In another aspect, at least one of the first and second chimneys may comprise a fastener member for fastening to a neck of the receptacle.

According to still another aspect, the first and second chimneys may be connected together at their bases by the wall. The wall may extend generally transversely to the axis of the neck of the receptacle. Alternatively or additionally, the first and second chimneys may be connected together by at least one partition. Such a partition may serve to further increase head loss, and/or to hold the applicator member. The at least one partition may extend over at least a fraction of its height going up from its base. In a variant, the first and second chimneys may be connected to each other by the wall only without any additional connecting member.

In yet still another aspect of the invention, the wall may completely close the bottom end of the space formed between the outer skirt and the second chimney, which may serve to avoid feeding substance to the bottom portion of the applicator member which is engaged in this space.

In one aspect, the applicator member may be configured to bear against a free end of the second chimney.

In another aspect of the invention, the applicator member may comprise at least one annular groove that may be radially open towards the outside.

In some aspects, the applicator member may comprise a base portion that may be stationary relative to the receptacle. Alternatively, the applicator member may comprise a base portion that may be movable relative to the receptacle. The base portion may be movable against a return action of a resilient return member. The return member may comprise a helical spring.

According to one aspect, the applicator member may be compressible. For example, the applicator member may comprise a foam. The applicator member may include flocking. Where appropriate, the applicator member may also contain a bactericidal or fungicidal agent.

In various aspects, the device may further comprise a cap, or any other suitable closure member, for closing the receptacle. The cap may be fastened to the receptacle in a leaktight manner. The applicator member may be compressed when the cap is in place on the receptacle. Conversely, removal of the cap may cause an expansion of the applicator member.

In another aspect, the chimney may extend along an axis that may coincide with a longitudinal axis of the receptacle. Alternatively, the chimney may extend along an axis that may form a non-zero angle relative to a longitudinal axis of the receptacle. The non-zero angle may permit the receptacle to have a more ergonomic configuration.

In still another aspect, the receptacle may comprise an outer wall, and the substance may be in contact with said outer wall.

In some aspects, the substance may be contained in a limp bag. The receptacle may comprise a flexible wall substantially enclosing the bag. The receptacle may also comprise a first valve enabling air to enter into a space between the limp bag and the flexible wall, and the limp bag may comprise a second valve allowing the substance to flow in one direction only towards the chimney and the applicator member. At least one of the first and second valves may comprise a check valve.

In various aspects, the first space (i.e., inside the receptacle) and the second space (i.e., inside the chimney) may be in fluid communication with each other without using any valve or closure system. Alternatively, a suitable flow controller (e.g., a valve or a pump) may be used to supply the substance therethrough from the first space to the second space. The controller may be actuated by the user. Use of such a controller may prevent the substance from being released from the receptacle, especially when the device is being carried (e.g., in a handbag).

In some aspects, the receptacle may contain a variety of substance for application to a body (e.g., a cosmetic product and/or care product). For example, the substance may comprise a moisturizing cream, a self-tanning substance, or possibly a sunscreen product. In some examples, the product may comprise a makeup or a dermatological substance.

In an aspect, the applicator member may comprise a base portion configured to be fastened to the receptacle. The base portion may comprise a skirt extending along an axis and having a radial inner face. The receptacle may comprise a support extending in contact with said radial inner face. The support may contact the radial inner face of the skirt along at least a fraction of its height along the axis without contacting the radial inner face in every radial position with respect to the axis (i.e., for at least a fraction of its height along the axis, the support may contact the radial inner face over less than one complete turn about the axis). Such a configuration may enable the applicator member to be retained in a reliable manner (e.g., by clamping the skirt), while still allowing the applicator member to be supplied with the an appropriate amount of the substance (e.g., by selectively configuring a passage through which the substance may flow from the receptacle to the applicator member).

In one aspect, the flow controller may comprise a pump or a valve. The chimney may contact a base portion of the applicator member.

The device, according to various aspects of the invention, may enable a user to apply a substance in a satisfactory manner over a large area. The device may also reduce the risk of supplying the substance to the applicator member in excessive quantity or insufficient quantity. The device may also allow a user to easily determine the quantity that is being dispensed.

According to one aspect, the chimney may extend above the wall, and the second space may be separated from the first space by the wall. The support may not have a wall having cut-outs and/or extending above the chimney.

In an aspect of the invention, a third space may extend at least partially around the chimney. Alternatively or additionally, the third space may be situated inside another chimney. The presence of the third space may make it easier to adjust the flow rate of the substance, such that the device can be more appropriately customized according to the desired conditions for which the device is used and/or according to the nature of the substance and/or applicator member.

The applicator member may not have any split section or throughhole thereon. The applicator member may not fill the entire second space. The applicator member may be fixed on the receptacle during the application. The third space may open directly towards the applicator member.

In another aspect, when a plurality of orifices open out into the first and second spaces, the first chimney may be configured to contact the base portion of the applicator member. The first chimney may thus contribute to the retaining of the applicator member by the receptacle, while avoiding the problems of overfeeding the applicator member with the substance by the effect of additional head loss created by the plurality of orifices.

The second and third spaces may be in permanent fluid communication with the supply of substance.

In various aspects, the applicator surface of the applicator member may have any shape. For example, the applicator surface may have any shape that is suitable for a particular body portion where the substance is intended to be applied. For example, the applicator surface may be generally outwardly convex.

Additionally or alternatively, the applicator member may have at least one alternating projection and/or depression (e.g., indentation) portion. Such a configuration may allow a user to apply the substance in a localized area. The applicator member may also present an applicator surface of a shape that is generally conical, pyramid-shaped, or chamfered. The applicator surface may also extend, by way of example, in a direction that is substantially perpendicular to the axis of the first chimney.

The applicator member may comprise a base portion extending along the axis X and a portion configured to apply the substance (e.g., applicator portion). The thickness of the base portion (as measured perpendicular to the axis X) may be greater than or equal to the thickness of the applicator portion (as measured along the axis X).

According to still another aspect of the invention, a device for packaging and applying a substance may comprise a first space inside a receptacle for containing a supply of substance, an applicator member suitable for applying the substance, a wall extending between the first space and the applicator member, at least one chimney extending from the wall and defining a second space therein, at least one orifice providing flow communication between the first and second spaces, and a third space capable of being supplied with the substance and separated at least partially from the second space by at least the chimney, wherein the wall may comprise at least one opening to enable a circulation of the substance between the first space and the third space.

In one aspect, a device for packaging and applying a substance may comprise a first space inside a receptacle for containing a supply of substance, an applicator member suitable for applying the substance, a wall extending between the first space and the applicator member, at least one chimney extending from the wall and defining a second space therein, at least one orifice providing flow communication between the first and second spaces, and a third space capable of being supplied with the substance and separated at least partially from the second space by at least the chimney, wherein the at least one chimney may comprise a lateral opening to enable a circulation of the substance between the second space and the third space.

According to another aspect of the invention, a device for packaging and applying a substance may comprise a first space inside a receptacle for containing a supply of substance, an applicator member suitable for applying the substance, a wall extending between the first space and the applicator member, at least one chimney extending from the wall and defining a second space therein, and a plurality of orifices opening out into the first and second spaces, wherein the at least one chimney may extend at least partially inside the applicator member.

In still another aspect, when the applicator member is in use and/or when a closure member is place on the receptacle, the applicator member may contact the free edge of the chimney. When not in use and/or when the closure member is not in place, the applicator member may not bear against the free edge.

In an aspect, the applicator member may be fixed inside an outer skirt of the support. The skirt many not have any rim at its upper end portion that may be oriented radially outwardly. This may facilitate the manufacture of the device. The applicator member may be fixed on a monolithic support insertable in a neck of the receptacle.

Some aspects of the invention may provide a device for packaging and applying a substance, comprising a first space inside a receptacle for containing a supply of substance, an applicator member suitable for applying the substance, a wall extending between the first space and the applicator member, a first chimney extending from the wall and defining a second space therein, a second chimney around the first chimney, and a third space between the first and second chimneys, wherein the applicator member may extend at least partially around the second chimney, and wherein the third space may open out entirely towards the applicator member.

As used herein, the term “open out entirely” should be understood as meaning that no intermediate member, such as, for example, a grid, is interposed between the third space and the applicator member.

Aside from the structural arrangements set forth above, the invention could include a number of other arrangements, such as those explained hereinafter. It is to be understood that both the foregoing description and the following description are exemplary.

The accompanying drawings, which are incorporated in and constitute a part of this specification, illustrate a number of non-limiting embodiments of the invention and together with the description, serve to explain the principles of the invention.

FIG. 1 is an axial cross-section view of a device for packaging and applying a substance, according to an exemplary embodiment of the invention.

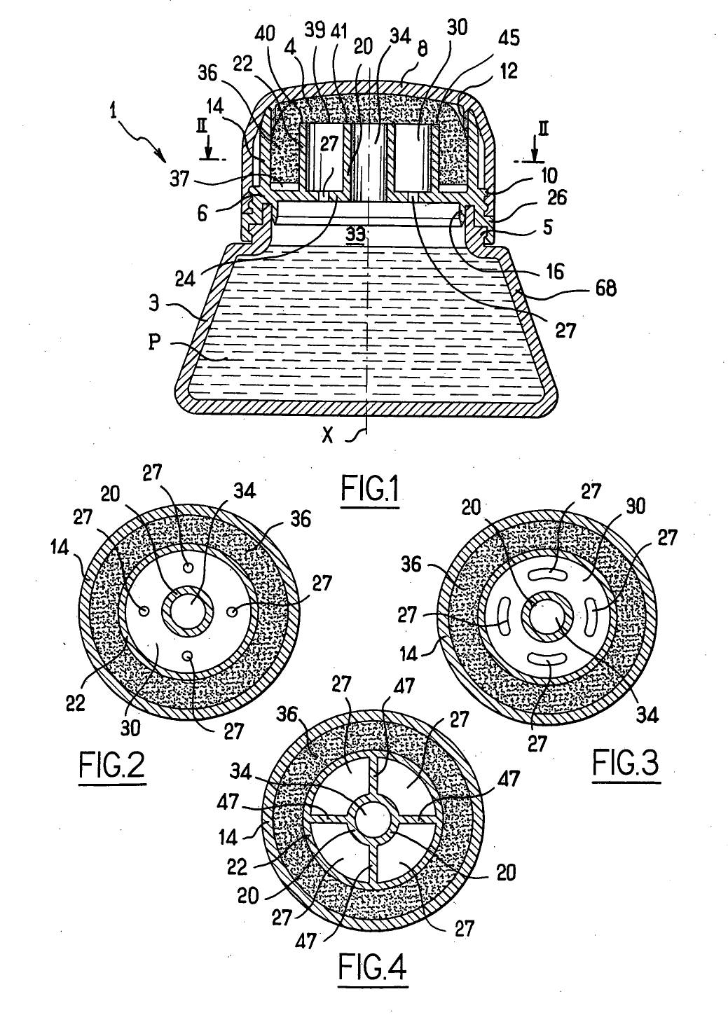

FIG. 2 is a cross-section view of the device shown in FIG. 1 along the elevational level II-II.

FIGS. 3 to 10 are cross-section views analogous to FIG. 2, illustrating various exemplary embodiments of the device.

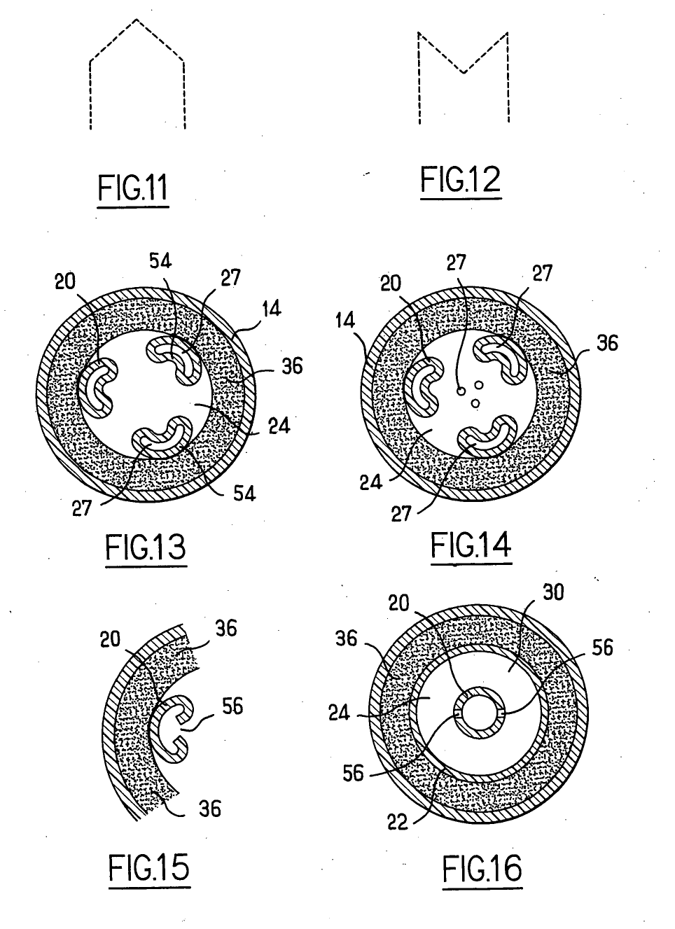

FIGS. 11 and 12 are schematic illustrations of an enveloping profile of chimneys, according to various exemplary embodiments of the invention.

FIGS. 13 and 14 are cross-section views of a device, analogous to FIG. 2, illustrating variant embodiments.

FIG. 15 is a partial cross-section view of a device, illustrating a variant configuration for a chimney.

FIGS. 16 and 17 are cross-section views of a device, analogous to FIG. 2, illustrating variant embodiments.

FIG. 18 is a partial, axial cross-section view of the device shown in FIG. 17 along the axial plane XVIII-XVIII, illustrating an exemplary embodiment of a dispenser head.

FIG. 19 is a partial, axial cross-section view of a device, analogous to FIG. 18, illustrating another exemplary embodiment of a dispenser head.

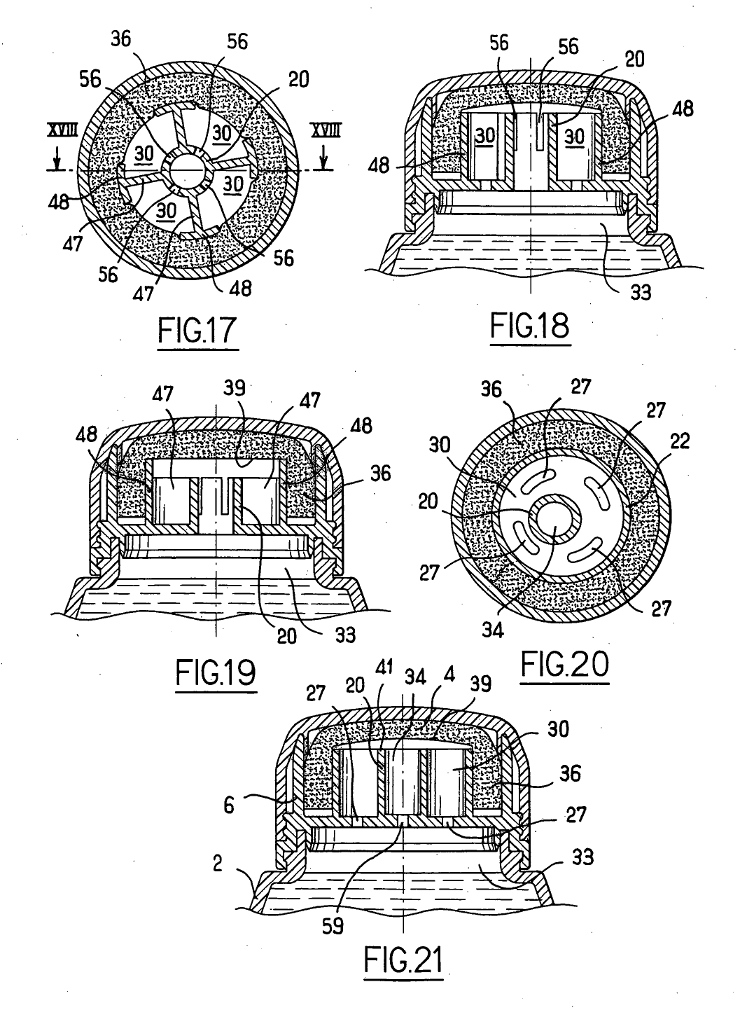

FIG. 20 is a cross-section view analogous to FIG. 17, illustrating a variant embodiment of the device.

FIGS. 21 to 24 are axial cross-section views of a device for packaging and applying a substance, illustrating various exemplary embodiments of a dispenser head.

FIGS. 25 to 29 are partial cross-section views of a device for packaging and applying a substance, illustrating various exemplary embodiments of an applicator member and a support.

FIGS. 30 and 31 are axial cross-section views of a device for packaging and applying a substance, according to various exemplary embodiments the invention.

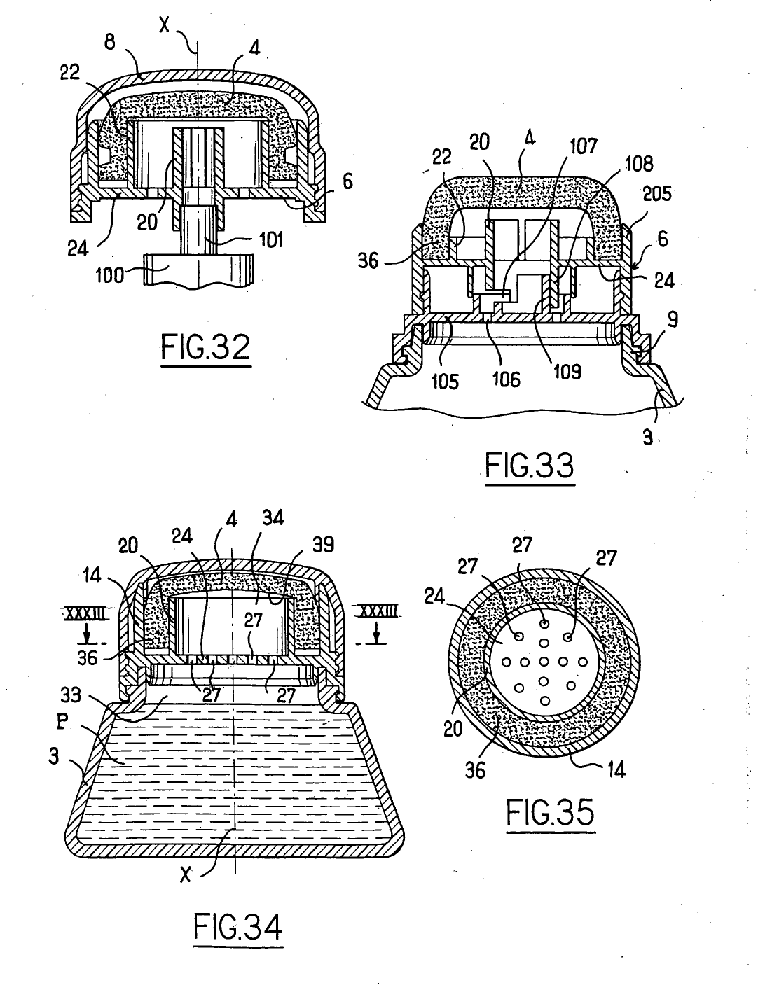

FIG. 32 is a partial, axial cross-section view of a device for packaging and applying a substance, according to still another exemplary embodiment of the invention.

FIG. 33 is a partial, axial cross-section view of a device for packaging and applying a substance, according to still another exemplary embodiment of the invention, illustrating a flow controller system for controlling flow communication between an applicator member and a supply of substance.

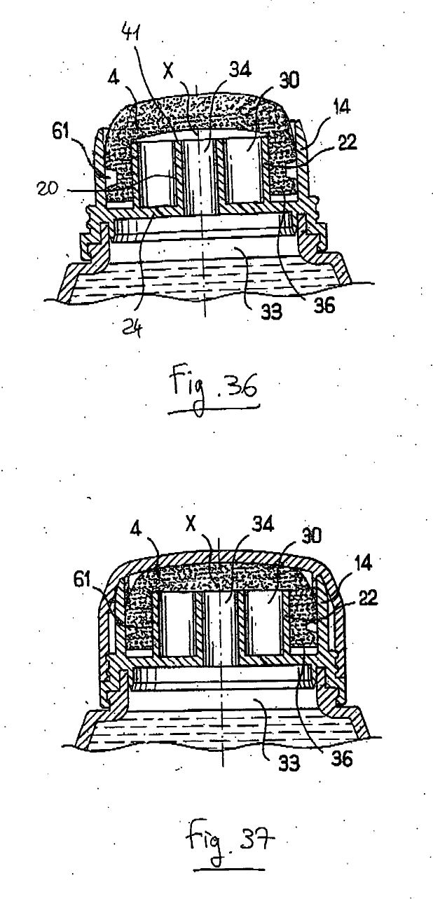

FIG. 34 is an axial cross-section view of a device for packaging and applying a substance, according to still another exemplary embodiment the invention.

FIG. 35 is a cross-section view of the device shown in FIG. 34 along the elevational level XXXV-XXXV.

FIG. 36 is a partial, axial cross-section view of a device for packaging and applying a substance, illustrating an open condition with a closure member removed.

FIG. 37 is a partial, axial cross-section view of the device shown in FIG. 36, illustrating a closed condition with a closure member in place.

Reference will now be made in detail to the exemplary embodiments of the invention, examples of which are illustrated in the accompanying drawings. Wherever possible, the same reference numbers will be used throughout the drawings to refer to the same or like parts. It is to be understood that both the foregoing general description and the following detailed description are exemplary and explanatory only and are not restrictive of the invention, as claimed.

FIG. 1 shows a device 1 comprising a receptacle 3 configured to contain a supply of substance P and an applicator member 4 configured to be fastened to the receptacle 3. The applicator member 4 may be permeable to the substance P and also capable of being filled with the substance P.

The body of the receptacle 3 may comprise a neck 5 extending from the body and about an axis X, to which a support 6 carrying an applicator member 4 may be fastened by, for example, snap-fastening or screw-fastening. In a variant, the support 6 may be integrally formed with at least a portion of the receptacle 3 by molding, for example, a thermoplastic material.

The device 1 may also include a cap 8 or any other suitable closure member associated with the support 6 and/or the receptacle 3 for closing the receptacle. For example, as shown in FIG. 1, the support 6 may include an outer skirt 14, and the cap 8 may engage with the outer skirt 14 (e.g., via screw-fastening or snap-fastening) so as to provide a leaktight enclosure of the substance P within the device 1. For this purpose, the outer skirt 14 may comprise a thread 10 corresponding to another thread of the cap 8.

As shown in FIG. 1, the cap 8 may also include an annular sealing lip 12 bearing in a leaktight manner against the outer skirt 14 of the support 6.

The support 6 may also include a sealing lip 16 bearing in a leaktight manner against the radial inner surface of the neck 5, as shown in FIG. 1.

In various exemplary embodiments, the support 6 may comprise a first chimney 20 and a second chimney 22. The first and second chimneys 20, 22 may be coaxial with one another. In some exemplary embodiments, the two chimneys 20, 22 may be cylindrical about the axis X. The axis X may coincide with the axis of the neck 5.

In an exemplary embodiment, the outside diameter of the second chimney 22 may be substantially equal to three times the outside diameter of the first chimney 20. By way of example only, the outside diameter of the first chimney 20 may be equal to about 7 mm, and the outside diameter of the second chimney 22 may be equal to about 21 mm. As is apparent, the invention is not limited to particular values of the diameters.

The support 6 may include a transverse wall 24 extending in a plane substantially perpendicular to the axis X. The two chimneys 20, 22 may be connected at their bases to the transverse wall 24. At the periphery of the transverse wall 24, the outer skirt 14 may extend upwardly, and a rim 26 may extend downwardly. The rim 26 may be configured to be snap-fastened or screw-fastened to the neck 5 of the receptacle 3.

In various exemplary embodiments, the transverse wall 24 may include at least one orifice 27 (or openings) having an axis parallel to the axis X. The at least one orifice 27 may provide fluid communication between an annular groove 30 formed between the first and second chimneys 20, 22 and the space 33 inside the receptacle 3 for containing the supply of substance P. The orifice(s) 27 may be formed by piercing the transverse wall 24.

The space 34 inside the first chimney 20 may also be in fluid communication with the inside space 33 of the receptacle 3.

In some exemplary embodiments, the substance P may flow through the groove 30 and/or through the inside space 34 of the first chimney 20 to reach the applicator member 4 when the receptacle 3 is placed in a head-down position, or when the receptacle 3 is shaken.

In various exemplary embodiments, the support 6 may be stationary relative to the receptacle 3. In a variant, the support 6 may be movable (e.g., axially and/or rotatably) relative to the receptacle 3. The support 6 may be configured in such a way that, in cooperation with a closure system, the inside space 33 may have a fluid communication with the applicator member 4 in a selective manner, as described in detail below.

Referring to FIG. 1, the applicator member 4 may be fastened to the support 6 via a base portion 36 (e.g., skirt) having a generally tubular shape. The base portion 36 may be clamped in the annular groove 37 formed between the outer skirt 14 of the support 6 and the second chimney 22.

The base portion 36 may be fastened in a variety of different ways. For example, the base portion 36 may be heat-sealed or interference-fitted with at least one of the outer skirts 14, the second chimney 22, and the transverse wall 24.

In an exemplary embodiment, the thickness of the base portion 36 (as measured perpendicular to the axis X), for example, before being mounted on the support 6, may be greater than the thickness of the part of the applicator member (e.g., central part) used to apply the substance (as measured along the axis X). The thickness of the part used to apply the substance may vary depending on the nature of the substance. For example, the thickness may be smaller as the substance is more viscous.

Where appropriate, an additional part may be fitted to the support 6 in order to retain the applicator member 4 thereto. The additional part may be fastened to the support 6 by snap-fastening, adhesive, and/or heat-sealing.

In some exemplary embodiments, the applicator member 4 may include an inner face 39 that may rest against a free edge 40 of the second chimney 22 and/or against a free edge 41 of the first chimney 20, as can be seen in FIG. 1. The first and second chimneys 20, 22 may thus at least partially support the applicator member 4 while it is being pressed against a surface being treated.

The orifices 27 may have a variety of different shapes, numbers, and dimensions. The number of chimneys 20, 22, and their respective positions and dimensions, may also vary. The shape, number, and dimension of the orifices 27 and/or the chimneys 20, 22 may be selected based on, at least partially, the nature of the substance (e.g., viscosity), the nature of the applicator member 4, and/or the type and location of the body portion being treated, so as to ensure, among other things, that the substance P does not flow at an extreme rate which may result in an excessive discharge of the substance P onto the applicator member 4.

The applicator member 4 may be made of various materials. For example, the applicator member 4 may be made of an elastically compressible material, such as, for example, a foam having open or semi-open cells. Suitable materials for such a foam may include, but not be limited to, polyethylene, polyvinyl chloride, polyether, polyester, acrylonitrile butadiene rubber, and styrene butadiene rubber. Any other material known in the art may also be used alternatively or additionally.

In various exemplary embodiments, the applicator member 4 may be sufficiently compressible so as to permit deformation while being used.

When the cap 6 is in place on the receptacle 3, as shown in FIG. 1, the applicator member 4 may be compressed, thus ensuring that, when the cap is unscrewed, the applicator member 4 may expand. In a variant, the applicator member may not need be compressed when the cap 8 is in place on the receptacle 3.

In operation, the user may shake the receptacle 3 or turn it upside-down, thereby enabling the substance P to flow by gravity into the annular groove 30 and/or into the inside space 34 of the first chimney 20 in order to bring the substance in contact with the inside face 39 of the applicator member 4 and to feed the applicator member with the substance P. The user may then hold the device 1 in any orientation (e.g., with the applicator member 4 pointing upwards or downwards) and apply the substance P by bringing the applicator member 4 in contact against a body surface being treated. If the device 1 is being used with the applicator member 4 pointing downwards, as is apparent, the substance P may be continuously supplied to the applicator member 4 by gravity.

The applicator member 4 may not be supplied by gravity. For example, in various exemplary embodiments, the substance P may be supplied to the applicator member 4 by, for example, utilizing a differential pressure. For example, the substance P in the receptacle 3 may be pressurized, and the substance P may be supplied to the applicator member 4 by using a suitable actuatable flow controller (e.g., a valve or a pump). The substance P may also be supplied to the applicator member by manually squeezing the wall of the receptacle 3.

As briefly mentioned above, the number and shape of the orifices 27, that may allow the substance P to flow between the annular groove 30 and the inside space 33 of the receptacle 3, may be modified. For example, as shown in FIG. 3, the orifices 27 may have a kidney shape.

It may also be possible to make the orifices 27 in the form of perforations formed between partitions 47 (e.g., walls) interconnecting the first and second chimneys 20, 22, as shown in FIG. 4. These partitions 47 may extend over all or part of the height of the chimneys 20, 22 and may contact the applicator member 4.

In an exemplary embodiment, the partitions 47 may compartmentalize the support 6 to, for example, increase head loss or improve the distribution of the substance P within the applicator member 4.

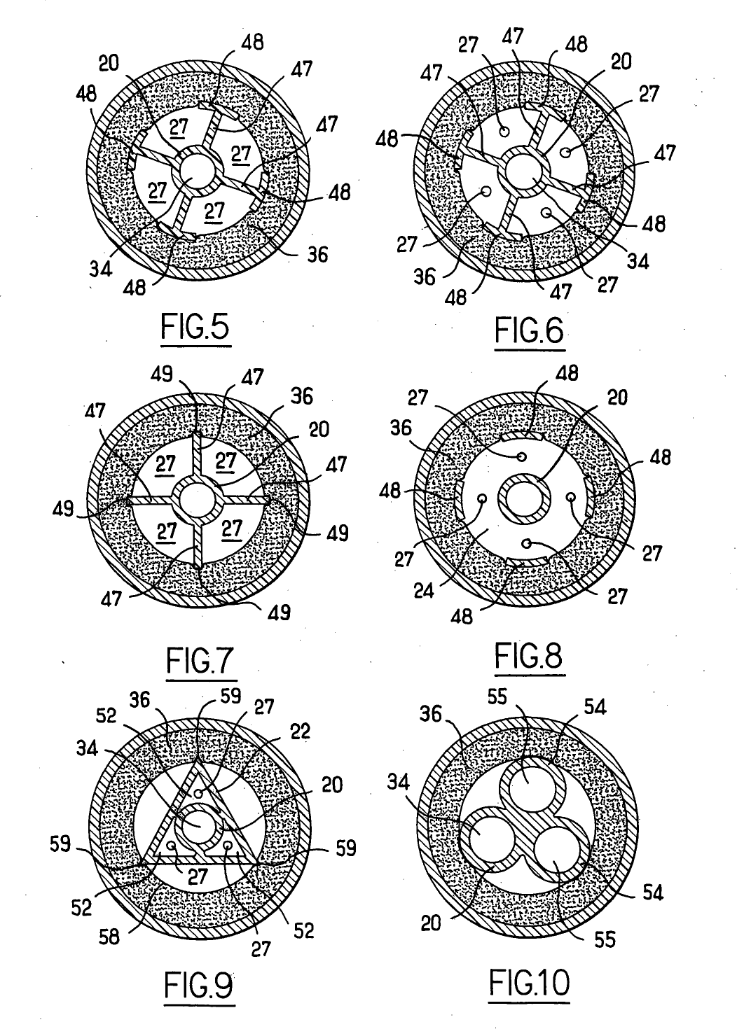

Referring to FIG. 5, uprights 48 may replace the continuous second chimney 22. To support the uprights 48, the partitions 47 may be connected to the uprights 48 at their ends adjacent the base portion 36 of the applicator member 4. The base portion 36 may then be held clamped between the uprights 48 and the outer skirt 14 of the support 6.

Where appropriate, each of the spaces formed between two adjacent partitions 47 may communicate with the inside space 33 of the receptacle 3 via an orifice 27 (e.g., opening), as shown in FIG. 6. The orifice 27 may be made small so as to increase head loss.

In some exemplary embodiments, at least one of the partitions 47 may not have the upright 48. For example, as shown in FIG. 7, the partitions 47 may directly extend to the applicator member 4, so that their radially extended outer edges 49 may bear against the base portion 36 of the applicator member 4.

The variant embodiment shown in FIG. 8 may differ from the embodiment shown in FIG. 6 by the absence of the partitions 47. In this embodiment, the uprights 48 may be connected to the chimney 20 via the transverse wall 24. The space 30 (i.e., annular groove) extending around the chimney 20 may communicate with the inside space 33 of the receptacle 3 via the orifices 27. The orifices 27 may be situated at substantially halfway between the uprights 48 and the chimney 20, as shown in the figure.

In some exemplary embodiments, the first chimney 20 may be cylindrical and surrounded by the second chimney 22. At least one of the first and second chimneys 20, 22 may not be cylindrical. For example, at least one of the first and second chimneys 20, 22 may have a shape of a polygon (e.g., triangle, square, or hexagon). In the exemplary embodiment shown in FIG. 9, the second chimney 22 may have a triangular shape. The second chimney 22 may be connected at its bottom end to the transverse wall 24 and may cooperate with the first chimney 20 to define three spaces 52, as shown in FIG. 9. These spaces 52 may communicate with the inside space 33 of the receptacle 3 via the orifices 27 formed in the transverse wall 24. As shown, the transverse wall 24 may not have any orifice that opens out into the outside of the second chimney 22. The corner edges 39 of the second chimney 22 may press against the radial inner surface 58 of the applicator member 4 at, for example, the base portion 36. Therefore, the support 6 may contact the radial inner surface 58 of the applicator member 4 (e.g., the base portion 36), but without contacting every radial location of the inner surface 58 with respect to the axis X (i.e., less than one complete turn of the perimeter or circumference of the inner surface 58 around the axis X).

The base portion 36 may be retained on the support 6 by being clamped between the second chimney 22 and the outer skirt 14.

In some exemplary embodiments, the second chimney may not surround the first chimney. For example, the support 6 may comprise a plurality of chimneys that are not coaxial with respect one another. By way of example, FIG. 10 shows three adjacent chimneys 54 with each having its independent axis along which each extends axially. The three axes may define the vertices of a triangle, and the chimneys 54 may define at least one generator line that may bear against the radial inner surface 58 of the applicator member 4. The inside space 55 of each chimney 54 may be cylindrical, and may communicate at one end with the inside space 33 of the receptacle 3.

When the support 6 comprises a plurality of chimneys 54, the top edges 40, 45 of the chimneys 54 may define, for example, a projecting conical portion, as shown in FIG. 11, or a depressed conical portion, as shown in FIG. 12.

Referring to FIGS. 13 and 14, the chimneys 20, 54 may not be in contact with one another.

The transverse wall 24 may comprise at least one opening or orifice each corresponding to the respective chimney 20, 54. The flow area of the opening may be substantially equal to or less than the flow area of the respective chimney. Alternatively or additionally, the transverse wall 24 may include at least one additional orifice in, for example, its central region other than the region occupied by the chimneys 20, 54, as shown in FIG. 14.

By way of example only, FIGS. 13 and 14 show the chimneys having a kidney-shaped cross-section. It should be understood that the cross-sectional shape of the chimneys is not limited to the circular shape of FIG. 10 or the kidney-like shape of FIGS. 13 and 14. Instead, any other shapes or variations thereof may also be possible.

In some exemplary embodiments, at least one chimney may be provided with at least one slot 56, as shown in FIGS. 15 and 16.

In the embodiment shown in FIG. 16, the slots 56 may serve as a flow passage between the annular space 30 formed between the first and second chimneys 20, 22 and the inside space 33 of the first chimney 20. The annular space 30 may then receive the substance P from the inside space 33 through the slots 56. The transverse wall 24 may not have any orifice that opens out both into the annular space 30 and into the inside space 33, as shown in FIG. 16. In a variant, such an orifice may be provided.

In various exemplary embodiments, the slots 56 may communicate with the spaces 30 formed between the partitions 47, as shown in FIG. 17. In this embodiment, the transverse wall 24 may not have any orifice other than the orifice feeding the chimney 20. In a variant, the transverse wall 24 may have an additional orifice providing fluid communication between the spaces 30 and the inside space 33 of the receptacle 3, as shown in FIG. 18.

Referring to FIG. 19, the chimney 20 and the partitions 47 may have a height different from the height of the uprights 48. For example, the height of the chimney 20 and the partitions 47 may be shorter than the height of the uprights 48. Alternatively or additionally, the height of the chimney 20 may be different from the height of the partitions 47.

In a variant embodiment shown in FIG. 20, the first chimney 20 may not be coaxial with the second chimney 22.

The cross-sectional area inside the first chimney 20 may be constant throughout its height, including the location at which the chimney 20 may pass through the transverse wall 24. In various alternative embodiments, the cross-sectional area of the chimney 20 may not be constant. For example, as shown in FIG. 21, the inside space 34 of the chimney may communicate with the inside space 33 of the receptacle 3 via an orifice 59 in the transverse wall 24, where the flow area of the orifice 59 may be smaller than the cross-sectional area in the upper portion of the chimney 20.

The inner face 39 of the applicator member 4 may not contact the free edge 41 of the first chimney 20.

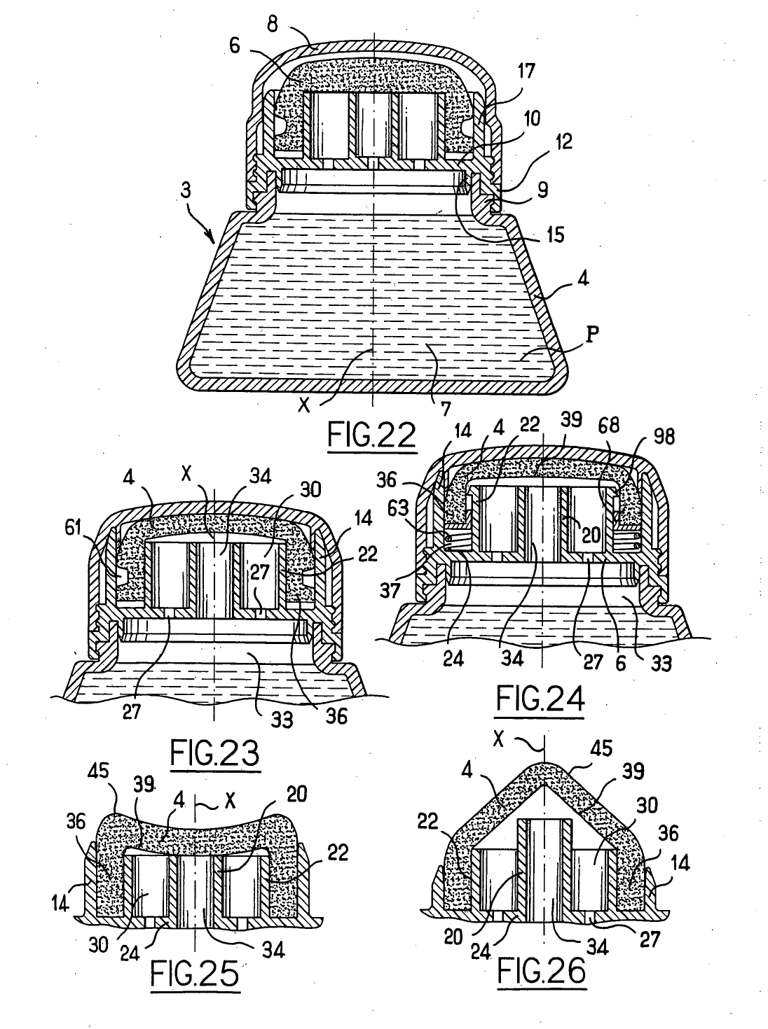

In some exemplary embodiments, as shown in FIG. 22, the cap 8 may be configured such that the cap 8 does not contact the applicator member 4 when the cap 8 is placed on the receptacle 3. Leak-tight closure of the receptacle 3 may be achieved by, for example, the cap 8 pressing against the radial outer surface of the outer skirt 17 or any other portion of the support 6.

The applicator member 4 may be made in various ways. For example, as shown in FIG. 23, an annular groove 61 may be formed near the bottom portion 36 adapted to engage with the space formed between the second chimney 22 and the outer skirt 14. The groove 61 may open radially towards the outside and against the outer skirt 14. Alternatively or additionally, the groove 61 may open upwardly (not shown). By way of example only, such a groove 61 may serve to impart additional deformability to the applicator member 4.

In some exemplary embodiments, the applicator member 4 may be stationary relative to the support 6. Alternatively, the applicator member 4 may be movable relative to the support 6, as shown in FIG. 24.

In the exemplary embodiment shown in FIG. 24, the base portion 36 may rest against a ring 68 in the annular groove 37 formed between the outer skirt 14 and the second chimney 22. This ring 68 may bear against a resilient return member 63, such as, for example, by a helical spring, that may bear against the transverse wall 24 at the bottom of the groove 37. The applicator member 4 may be arranged in such a manner that the applicator member 4 may rest on the support 6 when it is pressed against a surface being treated. The second chimney 22 may include teeth 98 for retaining the ring 68, as shown in the figure.

Mounting the applicator member 4 on such a resilient return member may further improve the comfort level during application.

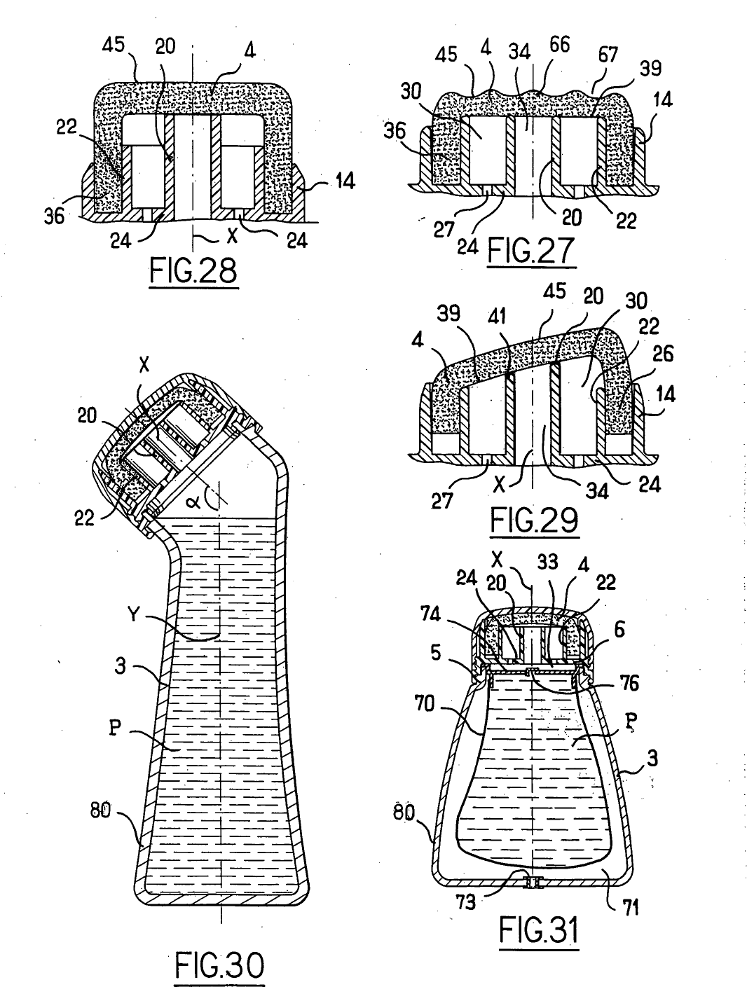

The applicator member 4 may have a wide variety of shapes. For example, in addition to the generally convex shapes shown in FIGS. 1, 18, 19, and 21-24, the outside surface 45 of the applicator member 4 may have a shape that is generally concave with respect to the axis X, as shown in FIG. 25. In other various exemplary embodiments, the outside surface 44 of the applicator member 4 may have: for example, a substantially conical or pyramid-shaped applicator face, as shown in FIG. 26; at least one alternating projection 66 and depression 67, as shown in FIG. 27; a generally flat applicator face (e.g., at least in a central region) that is substantially perpendicular to the axis X, as shown in FIG. 28; or a chamfered surface defining a sloping applicator face that forms an oblique angle relative to the axis X, as shown in FIG. 29.

As mentioned above, the chimney 20 may have a height that is different from the height of the adjacent chimney 22 or uprights 48. For example, as shown in FIGS. 26 and 28, the height of the chimney 20 may be greater than the adjacent chimney 22. This arrangement may avoid a suction effect when the applicator member is compressible and/or is compressed and released against the chimney 50.

When a plurality of chimneys are provided for the receptacle 3, it may be advantageous to include a central extension or a chimney in the central region so as to prevent the applicator member 4 from closing one or more chimneys that may be positioned closer to the base portion 36 of the applicator member 4.

The free end of the chimney 20 may define a slanted edge 41 extending in a plane that may intersect with the axis X of the chimney 20 obliquely, as shown in FIG. 29. Alternatively, the free end of the chimney 50 may define any other shape or form.

The receptacle 3 may have a variety of shapes. In particular, the receptacle 3 may have a shape that may facilitate holding or grasping of the receptacle 3 and/or application of the substance to the body. In an exemplary embodiment, the longitudinal axis Y of the receptacle 3 may form a non-zero angle α relative to the axis X, as shown in FIG. 30.

The receptacle 3 may have a flexible wall 80 so as to allow an elastic deformation of the receptacle 3. For example, the receptacle 3 may be made of a material having shape memory so that, when the receptacle 3 is deformed, the receptacle 3 may restore its original shape. Such a flexible wall may enable a user to dispense the substance P out of the receptacle 3 by squeezing the receptacle 3 (e.g., reducing the internal volume of the receptacle so as to increase the pressure inside the receptacle 3), thus making it easier for the substance P to flow through the applicator member 6.

The substance P may be contained in a limp bag 70, as shown in FIG. 31, which may be situated inside the receptacle 3. The space 71 between the bag 70 and the outer wall 68 of the receptacle 3 may communicate with the outside of the receptacle 3 through an air inlet valve 73 (e.g., a check valve) that, as will be described below, may selectively permit in-flow of air therethrough into the space 71. The bag 70 may be coupled to an end piece 74 disposed adjacent the neck 5 of the receptacle 3. In an exemplary embodiment, the end piece 74 may be held in the neck 5 by the support 6. The end piece 74 may include another check valve 76 (e.g., a substance-outlet check valve) that may selectively permit out-flow of the substance P out of the bag 70 therethrough when extra pressure is created inside the bag 70. At least one of the valves 73 and 76 may be made of an elastomer material by, for example, overmolding.

In operation, when a user squeezes the flexible wall 68 of the receptacle 3, the volume of the inside space 71 may decrease, causing the the pressure inside the bag 70 to increase. The pressure increase in the bag 70 may actuate the outlet valve 76 to open, causing the substance P to be expelled through the outlet valve 76. During the squeezing, the air inlet valve 93 may be maintained in a closed state. When the user releases the wall 68, the outlet valve 76 may be closed with the bag 70 remaining in the reduced volume since the outlet valve 76 only permits one-way flow (e.g., outflow of the substance). Furthermore, a suction condition may be established inside the space 71 due to the reduced volume of the bag 70 and the elasticity of the flexible wall 68. The suction condition inside the space 71 may actuate the air inlet valve 73 to open, allowing in-flow of air into the space 71 to bring the pressure back to its equilibrium pressure.

In some exemplary embodiments, the device may comprise a suitable dispensing member that may be actuated by a user to dispense the substance P out of the receptacle 3. For example, as shown in FIG. 32, the device may comprise a dispensing member 100, such as, for example, a pump, a valve, or any other suitable flow controller mechanism known in the art. The support 6 or the neck 5 of the receptacle 3 may be appropriately configured to accommodate such a dispensing member 100. For example, the support 6 may be arranged to cooperate with an actuator rod 101 of the dispensing member 100, as shown in FIG. 32, such that, when the rod 101 is displaced (e.g., by being depressed along the axis X against the support 5), the dispensing member 100 may be actuated to deliver the substance P to the applicator member 4 via, for example, the inside channel of the chimney 20. In various exemplary embodiments, the substance P contained within the receptacle 3 may be in a pressurized form.

It may also be possible to provide a temporary closure system for closing the flow communication between the supply of substance P contained in the receptacle 3 and the applicator member 4.

In still another exemplary embodiment of the invention, the support may constitute two or more interacting parts, where at least one of the parts may be movable relative to the other of the parts or the receptacle 3. By way of non-limiting example, FIG. 33 shows one part 205 of a support 6 that may be rotatably movable relative to another part 105 of the support 6, where the part 105 is fixedly coupled to the neck 9 of the receptacle 3. The fixed part 105 may have a transverse wall having at least one opening 106 passing therethrough and a concentric skirt 109 defining, in cooperation with another concentric skirt 108 of the movable part 205, an opening 107. The openings 106, 107 may define a passage through which the substance P may be delivered to the applicator member 4. The movable part 205 may be moved between a closed position and an open position to close and open the passage (e.g., the opening 107), respectively. For example, to close the passage, the movable part 205 may be rotated with respect to the fixed part 105 such that the skirt 108 of the movable part 205 may engage the skirt 109 of the fixed part 105 to close the opening 107. To open the passage, the movable part 205 may be rotated to open the opening 107, as shown in FIG. 33. Alternatively or additionally, a suitable closure system may be arranged so that opening and closing of the passage may be achieved by, for example, moving the movable part 205 axially relative to the fixed part 105.

In the various exemplary embodiments shown in FIGS. 1 to 31, the device may include one or more second spaces 30, 52, 55, for example, outside the second chimney 22 and into which the substance P may flow during utilization for the purpose of filling the applicator member. The presence of the one or more second space may provide the first chimney 20 with a cross-section that is smaller than the inside cross-section of the base portion 36 of the applicator member 4 so as to facilitate control of the quantity of substance with which the applicator member 4 may be supplied.

As shown in FIGS. 34 and 35, the chimney 20 may have an outer section corresponding substantially to the inner section of the base portion 36. Nevertheless, a plurality of orifices 27 may be formed through the transverse wall 24 that may open out into the space inside the chimney 20. These orifices 27 may form a grid that may reduce the rate at which the substance may flow towards the applicator member 4.

In some exemplary embodiments, as shown in FIGS. 36 and 37, the first chimney 20 may not have any lateral opening, orifice, or slot. Similarly, the transverse wall 24 may not have any opening, orifice, or slot that would otherwise allow the annular groove 30 to communicate directly with the internal space 33 of the receptacle 3. In this embodiment, similar to the embodiment shown in FIG. 23, the applicator member 4 may be fixed in a space between the second chimney 22 and the outer skirt 14. The height of the first chimney 20 may be substantially the same as the height of the second chimney 22.

As shown in FIG. 36, when the cover 8 or closure member is removed, the inside face 39 of the central part of the applicator member 4 may not contact with the free edge 41 of the first chimney 20. When the closure member 8 is placed on the receptacle 3, the base portion 36 of the applicator member 4 may be compressed or deformed, as shown in FIG. 37. This deformation may be facilitated by the presence of the annular groove 61 of the applicator member 4.

The central part of the applicator member 4 may also be moved axially towards the first chimney 20 by the presence of a gap between the inside surface of the applicator member 4 and the free edge 41 of the chimney 20. Therefore, when the closure member 8 is placed on the receptacle 3, the central part of the applicator member 4 may not be extremely compressed between the first chimney 20 and the bottom of the cap 8. This configuration may prevent the substance P impregnated onto the applicator member 4 from being expelled by the applicator member 4 and flowing back into the internal space 33 of the receptacle 3. By preventing the back flow of the substance P from the applicator member 4 into the receptacle 3, the risk of contamination (e.g., caused by impurities in the substance P that may have been in contact with the applicator member 4) may be reduced.

The groove 30 may open directly towards the applicator member 4. The inside face of the applicator member 4 may face the bottom of the groove 30 without having any grid interposed therebetween.

In the various exemplary embodiments described above, a wide variety of modification may be possible. For example, the receptacle 3 of the embodiment shown in FIG. 30 may be fitted with any one of the dispenser heads shown in, for example, FIGS. 3 to 24, and the applicator member 4 shown in those figures may be replaced by any one of the applicator members 4 shown in, for example, FIGS. 25 to 29.

Moreover, the applicator member 4 may be made of a material other than a foam. For example, the applicator member 4 may be made of a felt, a sponge, or a sintered plastic or inorganic material. The structure of the applicator member 4 may comprise a single block or multiple layers. For example, the applicator member 4 may have a woven or non-woven fabric and/or flocking on its surface.

The transverse wall 24 of the support 6 may also have a variety shapes. For example, the wall 24 may constituted no more than simple bridges of material.

The chimney may be continuous in the radial direction (e.g., circumferential direction if the chimney has a circular shape), presenting, where appropriate, portions of height and/or of radial extent that may be unequal.

Throughout the description, including in the claims, the term “a” should be understood as being synonymous with “at least one” (i.e., relating to both the singular and the plural) unless specified to the contrary.

It will be apparent to those skilled in the art that various modifications and variations can be made to the structure and methodology of the present invention. Thus, it should be understood that the invention is not limited to the examples discussed in the specification. Rather, the present invention is intended to cover modifications and variations.

1. A device for packaging and applying a substance, the device comprising:
a first space inside a receptacle for containing a supply of substance;
an applicator member suitable for applying the substance;
a wall extending between the first space and the applicator member;
at least one chimney extending from the wall and defining a second space therein;
at least one orifice providing flow communication between the first and second spaces; and
a third space capable of being supplied with the substance and separated at least partially from the second space by at least the chimney,
wherein the chimney comprises at least one opening for permitting flow of the substance between the second space and the third space.

2. The device according to claim 1, wherein the at least one orifice comprises a plurality of orifices opening out into the first and second spaces.

3. The device according to claim 1, wherein the chimney contacts a base portion of the applicator member.

4. The device according to claim 1, wherein the third space is in fluid communication with the first space via at least one orifice formed through the wall and opening out into the first and third spaces.

5. The device according to claim 1, wherein the third space is in fluid communication with the first space via the second space.

6. The device according to claim 1, wherein the third space communicates with the second space via at least one slot formed in the chimney.

7. The device according to claim 1, wherein the chimney comprises a free end opposite from the wall, the free end being substantially in contact with the applicator member.

8. The device according to claim 1, wherein the chimney comprises a free end opposite from the wall, the free end being spaced apart from the applicator member.

9. The device according to claim 1, wherein the applicator member extends at least partially around and above the second and third spaces.

10. The device according to claim 1, wherein the wall and the chimney are configured such that, when the device is held in a head-up position, substance contained in the second and third spaces returns to the first space.

11. The device according to claim 1, wherein the chimney is substantially cylindrical.

12. The device according to claim 11, wherein an outer diameter of the chimney ranges from about 5 mm to about 10 mm.

13. The device according to claim 1, wherein the chimney comprises a plurality of chimneys.

14. The device according to claim 1, wherein the chimney is a first chimney and wherein the device further comprises at least one second chimney surrounding the first chimney, the third space being defined at least partially between the first and second chimneys.

15. The device according to claim 14, wherein the first and second chimneys are coaxial.

16. The device according to claim 14, wherein the second chimney is substantially cylindrical.

17. The device according to claim 16, wherein an outer diameter of the second chimney ranges from about 12 mm to about 90 mm.

18. The device according to claim 1, wherein the chimney is a first chimney and wherein the device further comprises a second chimney, wherein the third space is defined inside the second chimney.

19. The device according to claim 18, wherein the second chimney does not surround the first chimney.

20. The device according to claim 14, wherein an outer diameter of the second chimney is greater than or equal to twice an outer diameter of the first chimney.

21. The device according to claim 14, wherein an outer diameter of the second chimney is substantially equal to three times an outer diameter of the first chimney.

22. The device according to claim 14, further comprising an outer skirt extending from the wall and cooperating with the second chimney to define a groove configured to receive a base portion of the applicator member.

23. The device according to claim 22, wherein said groove is an annular groove.

24. The device according to claim 14, wherein the first and second chimneys are made integrally by molding a plastic material.

25. The device according to claim 14, wherein at least one of the first and second chimneys comprises a fastener member for fastening to a neck of the receptacle.

26. The device according to claim 14, wherein the first and second chimneys are connected together at their bases by the wall.

27. The device according to claim 14, wherein the first and second chimneys are connected together by at least one partition.

28. The device according to claim 27, wherein said at least one partition extends over at least a fraction of its height going up from its base.

29. The device according to claim 14, wherein the applicator member is configured to bear against a free end of the second chimney.

30. The device according to claim 1, wherein the applicator member comprises at least one annular groove that is radially open towards the outside.

31. The device according to claim 1, wherein the applicator member comprises a base portion that is stationary relative to the receptacle.

32. The device according to claim 1, wherein the applicator member comprises a base portion that is movable relative to the receptacle.

33. The device according to claim 32, wherein the base portion is movable against a return action of a resilient return member.

34. The device according to claim 33, wherein said return member comprises a helical spring.

35. The device according to claim 1, wherein the applicator member is compressible.

36. The device according to claim 1, wherein the applicator member comprises a foam.

37. The device according to claim 1, further comprising a cap for closing the receptacle.

38. The device according to claim 37, wherein the applicator member is compressed when the cap is in place on the receptacle.

39. The device according to claim 1, wherein the chimney extends along an axis that coincides with a longitudinal axis of the receptacle.

40. The device according to claim 1, wherein the chimney extends along an axis that forms a non-zero angle relative to a longitudinal axis of the receptacle.

41. The device according to claim 1, wherein the receptacle comprises an outer wall, and wherein the substance is in contact with said outer wall.

42. The device according to claim 1, wherein the substance is contained in a limp bag.

43. The device according to claim 42, wherein the receptacle comprises a flexible wall substantially enclosing the bag, wherein the receptacle comprises a first valve enabling air to enter into a space between the limp bag and the flexible wall, and wherein the limp bag comprises a second valve allowing the substance to flow in one direction only towards the chimney and the applicator member.

44. The device according claim 43, wherein at least one of the first and second valves comprises a check valve.

45. The device according to claim 1, wherein the receptacle contains a substance for application to a body.

46. The device according to claim 45, wherein the substance comprises a self-tanning substance.

47. The device according to claim 1, wherein the applicator member comprises a base portion configured to be fastened to the receptacle, the base portion comprising a skirt extending along an axis and having a radial inner face,
wherein the receptacle comprises a support extending in contact with said radial inner face, and
wherein the support contacts the radial inner face of the skirt along at least a fraction of its height along the axis without contacting the radial inner face in every radial position with respect to the axis.

48. A device for packaging and applying a substance, the device comprising:
a first space inside a receptacle for containing a supply of substance;
an applicator member suitable for applying the substance;
a wall extending between the first space and the applicator member;
at least one chimney extending from the wall and defining a second space therein;
at least one orifice providing flow communication between the first and second spaces; and
a third space capable of being supplied with the substance and separated at least partially from the second space by at least the chimney,
wherein the chimney is configured to enable a communication of the substance between the second space and the third space.

49. A device for packaging and applying a substance, the device comprising:
a first space inside a receptacle for containing a supply of substance;
an applicator member suitable for applying the substance;
a wall extending between the first space and the applicator member;
at least one chimney extending from the wall and defining a second space therein;
at least one orifice providing flow communication between the first and second spaces; and
a third space capable of being supplied with the substance and separated at least partially from the second space by at least the chimney,
wherein the wall and the chimney are configured to permit the substance contained in the second and third spaces to return to the first space when the device is in a head-up position.

50. A device for packaging and applying a substance, the device comprising:
a first space inside a receptacle for containing a supply of substance;
an applicator member suitable for applying the substance;
a wall extending between the first space and the applicator member;
at least one chimney extending from the first wall and defining a second space therein;
at least one orifice providing flow communication between the first and second spaces;
a third space capable of being supplied with the substance and separated at least partially from the second space by at least the chimney, and
a flow controller for controlling flow of the substance.

51. The device according to claim 50, wherein the flow controller comprises a pump or a valve.

52. A device for packaging and applying a substance, the device comprising:
a first space inside a receptacle for containing a supply of substance;
an applicator member suitable for applying the substance;
a wall extending between the first space and the applicator member;
at least one chimney extending from the wall and defining a second space therein; and
a plurality of orifices providing flow communication between the first and second spaces,
wherein the chimney extends at least partially inside the applicator member.

53. The device according to claim 52, wherein the chimney contacts a base portion of the applicator member.

54. The device according to claim 52, wherein the chimney comprises a free end opposite from the wall, the free end being substantially in contact with the applicator member.

55. The device according to claim 52, wherein the chimney comprises a free end opposite from the wall, the free end being spaced apart from the applicator member.

56. The device according to claim 52, wherein the chimney is substantially cylindrical.

57. The device according to claim 56, wherein an outer diameter of the chimney ranges from about 5 mm to about 10 mm.

58. The device according to claim 52, wherein the applicator member comprises at least one annular groove that is radially open towards the outside.

59. The device according to claim 52, wherein the applicator member comprises a base portion that is stationary relative to the receptacle.

60. The device according to claim 52, wherein the applicator member comprises a base portion that is movable relative to the receptacle.

61. The device according to claim 60, wherein the base portion is movable against a return action of a resilient return member.

62. The device according to claim 61, wherein said return member comprises a helical spring.

63. The device according to claim 52, wherein the applicator member is compressible.

64. The device according to claim 63, wherein the applicator member comprises a foam.

65. The device according to claim 52, further comprising a cap for closing the receptacle.

66. The device according to claim 65, wherein the applicator member is compressed when the cap is in place on the receptacle.

67. The device according to claim 52, wherein the chimney extends along an axis that coincides with a longitudinal axis of the receptacle.

68. The device according to claim 52, wherein the chimney extends along an axis that forms a non-zero angle relative to a longitudinal axis of the receptacle.

69. The device according to claim 52, wherein the receptacle comprises an outer wall, and wherein the substance is in contact with said outer wall.

70. The device according to claim 52, wherein the substance is contained in a limp bag.

71. The device according to claim 70, wherein the receptacle comprises a flexible wall substantially enclosing the bag, wherein the receptacle comprises a first valve enabling air to enter into a space between the limp bag and the flexible wall, and wherein the limp bag comprises a second valve allowing the substance to flow in one direction only towards the chimney and the applicator member.

72. The device according claim 71, wherein at least one of the first and second valves comprises a check valve.

73. The device according to claim 52, wherein the receptacle contains a substance for application to the body.

74. The device according to claim 73, wherein said substance comprises a self-tanning substance.

75. The device according to claim 52, wherein the applicator member comprises a base portion configured to be fastened to the receptacle, the base portion comprising a skirt extending along an axis and having a radial inner face,
wherein the receptacle comprises a support extending in contact with said radial inner face, and
wherein the support contacts the radial inner face of the skirt along at least a fraction of its height along the axis without contacting the radial inner face in every radial position with respect to the axis.

76. A device for packaging and applying a substance, the device comprising:
a first space inside a receptacle for containing a supply of substance;
an applicator member suitable for applying the substance;
a wall extending between the first space and the applicator member;
at least one chimney extending from the wall and defining a second space therein;
at least one orifice providing flow communication between the first and second spaces; and
a third space capable of being supplied with the substance and separated at least partially from the second space by at least the chimney,
wherein the wall comprises at least one opening to enable a circulation of the substance between the first space and the third space.

77. A device for packaging and applying a substance, the device comprising:
a first space inside a receptacle for containing a supply of substance;
an applicator member suitable for applying the substance;
a wall extending between the first space and the applicator member;
at least one chimney extending from the wall and defining a second space therein;
at least one orifice providing flow communication between the first and second spaces; and
a third space capable of being supplied with the substance and separated at least partially from the second space by at least the chimney,
wherein the at least one chimney comprises a lateral opening to enable a circulation of the substance between the second space and the third space.

78. A device for packaging and applying a substance, the device comprising:
a first space inside a receptacle for containing a supply of substance;
an applicator member suitable for applying the substance;
a wall extending between the first space and the applicator member;
at least one chimney extending from the wall and defining a second space therein; and
a plurality of orifices opening out into the first and second spaces,
wherein the at least one chimney extends at least partially inside the applicator member.

79. A device for packaging and applying a substance, the device comprising:
a first space inside a receptacle for containing a supply of substance;
an applicator member suitable for applying the substance;
a wall extending between the first space and the applicator member;
a first chimney extending from the wall and defining a second space therein;
a second chimney around the first chimney; and
a third space between the first and second chimney,
wherein the applicator member extends at least partially around the second chimney, and
wherein the third space opens out entirely towards the applicator member.
